(19) United States
(12) Patent Application Publication
(10) Pub. No.: US 2020/0128850 A1
(43) Pub. Date: Apr. 30, 2020

(54) Dried, Toasted Marbits and Method of Preparing the Same

(71) Applicant: General Mills, Inc., Minneapolis, MN (US)

(72) Inventors: Darryl J Ballman, Wyoming, MN (US); Steve C Robie, Plymouth, MN (US)

(73) Assignee: General Mills, Inc., Minneapolis, MN (US)

(21) Appl. No.: 16/619,000

(22) PCT Filed: Nov. 8, 2017
(86) PCT No.: PCT/US2017/060590

§ 371 Date: Dec. 3, 2019

(51) Int. Cl. A23G 3/54; A23G 3/52; A23L 7/126

(52) U.S. Cl. CPC A23G 3/54; A23V 2002/00; A23L 7/126; A23G 3/52

(57) ABSTRACT

A food product is prepared by drying a marshmallow to provide a marbit having a water activity in the range of 0.1-0.4 in the center of the marbit. The marbit is then heated to provide a toasted marbit, with at least one outer surface portion of the marbit being toasted to result in a flavor change. The toasted marbit can be used in a wide variety of snack products, such as combining toasted marbits with a graham cracker-flavored cereal ingredient and a chocolate-flavored cereal ingredient to form a ready-to-eat cereal.

### BACKGROUND OF THE INVENTION

The present invention pertains to food products and, more particularly, to aerated confectionery products.

Aerated confections are popular food items. Some aerated confections comprise a fat constituent while others are substantially free of such fat constituents. An illustrative fat-free aerated confection is the common marshmallow. Such marshmallow products are familiar in both larger and smaller sizes. It is well known that such marshmallows are soft and pliable when fresh but will stale by losing moisture and become hard. Indeed, purposefully pre-dried aerated confections are also well known. These products, particularly in smaller or bite sizes, are commonly added to certain popular ready-to-eat (“RTE”) breakfast cereals, e.g., Lucky Charms® brand RTE cereal. Due to their small size (i.e., having a piece count of 3 to 6 per gram), these dried aerated confectionery marshmallow products are sometimes colloquially referred to as “marshmallow bits” or “marbits”. Marbits are pre-dried to the low water activity (0.1-0.4) of RTE cereals prior to mixing with other cereal pieces to reduce unwanted moisture migration from the marbits to the other cereal pieces and thus to forestall the multiple problems resulting therefrom. These dried marshmallow pieces exhibit desirable crisp, frangible eating qualities. Thus, such dried confections are crunchy rather than soft or chewy.

While there are many types of marshmallow products on the market, their methods of preparation generally fall into two main process groups: extruded marshmallow and deposited marshmallow. In both types, a sugar syrup, a structuring agent, and a whipping agent are the main ingredients. Often, gelatin is used as both the whipping agent to form an aerated foam as well as the structuring agent for setting the foam. Typically, the sugar syrup is heated to dissolve solids, boiled to reduce moisture, cooled down, and then combined with the gelatin to form a slurry. That slurry is then aerated to form a foam. Optionally, colors and flavors are added to the foam immediately after aeration, although in certain embodiments these adjuvants are added to the syrup prior to aerating. The particular marshmallow product can be formed into its final shape by an extrusion process. That is, after aeration, the foam is extruded through a die to form a rope. The die imparts the desired peripheral shape to the rope. The rope is allowed to rest briefly to set, and it can be dusted or enrobed with starch before being cut into desired sizes. For dried marshmallows, the process can additionally include one or more drying steps. See, for example, U.S. Pat. No. 4,785,551, issued Nov. 2, 1988 to W. J. Meyer and titled “Method of Drying Confection Pieces”.

Consumer food products require constant innovation to maintain popularity. Innovation and change are even more important for those consumer food products oriented towards children. Accordingly, while crisp or frangible dried marshmallow confections suitable for addition to RTE cereals are already popular, it would be desirable to be able to provide dried marshmallow confections having novel flavors.

### SUMMARY OF THE INVENTION

In view of the above, the present invention provides dried marshmallow products in the form of marbits having a novel flavor, as well as a method of producing such products. Specifically, the marbits, which exhibit a water activity in the range of 0.1-0.4, have at least one surface portion which is toasted in order to provide the novel flavor. The toasted marbits can be incorporated into various food products, such as RTE cereals, cereal bars or other snack products. One particularly preferred embodiment involves the incorporation of the toasted marbits into a s'mores-flavored RTE cereal or cereal bar, i.e., with the toasted marbits being combined with chocolate- and graham cracker-flavored cereal pieces.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 shows a process for preparing an RTE cereal in accordance with the present invention;

FIG. 2 is a perspective view of an RTE cereal produced in accordance with the process of FIG. 1;

FIG. 3 is a perspective view of the RTE cereal of FIG. 2, with a toasted marbit shown on a spoon; and

FIG. 4 is a cross-section of a toasted marbit made in accordance with the invention.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention. In addition, any specific numerical value listed herein includes a margin of error of +/−5%. Accordingly, a mass of 10.0 grams includes masses between 9.50 and 10.5 grams. Similarly, a range of 8.00-12.0 grams includes masses between 7.60 and 12.6 grams. The term “about” increases the margin of error to 10%. For numerical values expressed as percentages, the margin of error refers to the base numerical value. In other words, “about 20%” means 18-22% and not 10-30%.

In general, production of the marshmallow products of the present invention involves: 1) making marshmallows; 2) drying the marshmallows to provide dried marshmallows (i.e., marbits); and 3) heating the marbits to a temperature sufficient to toast at least one outer surface portion of each marbit. The toasted marbits can then be incorporated into food products, such as RTE cereals, cereal bars or other snack products. Preferably, the marbits are sized to have a piece count of 3-6 per gram. Although the present invention is not focused on the first and second steps, certain details of these steps are provided below for completeness.

Marshmallows can be produced by a variety of different methods and from a variety of different ingredients depending on the properties desired. In general though, marshmallows comprise a saccharide component, a foaming or whipping component and a structuring component. Typically, on a dry weight basis, marshmallows comprise 50-95% of the saccharide component (preferably 70-90%), 0.05-15% of the foaming or whipping component (preferably 1-4% and most preferably about 2.5%), and 0.5 to 20% of the structuring component (preferably 1-6% and most preferably about 2.5%).

The saccharide component can include disaccharides, such as sucrose; monosaccharides, such as glucose, dextrose and fructose; oligosaccharides; or mixtures thereof. As used herein, an “oligosaccharide” is a molecule containing two to twenty sugar units joined by glycosidic bonds. The soluble fiber inulin is one example of an oligosaccharide.

The foaming or whipping component can include a protein-based whipping agent, such as soy protein, albumen, sodium caseinate, whey protein, gelatin or mixtures thereof. Suitable non-proteinaceous whipping agents include low molecular weight surfactants (e.g., sodium lauryl sulfate (“SLS”), lecithin), polymers (e.g., methyl cellulose (“MC”), hydroxypropyl methyl cellulose (“HPMC”), propylene glycol alginate (“PGA”)) or mixtures thereof.

The structuring component can include gelatin; hydrophilic colloids, such as pectin; modified starches; gums, such as guar and carrageenan; or mixtures thereof. Thus, gelatin can be used as both the foaming and structuring component (and is often the only foaming and structuring agent).

If desired, marshmallows can additionally include one or more ingredients to improve their appearance, flavor, nutritional value and/or other organoleptic attributes.

Generally, the saccharide component is heated to dissolve solids, boiled to reduce moisture, cooled down, and then combined with the foaming and structuring components to form a slurry. That slurry is then aerated to form a foam. Optionally, colors and flavors are added to the foam immediately after aeration, although in certain embodiments these adjuvants are added prior to aerating. The marshmallows can be formed into their final shape by an extrusion or deposition process. That is, after aeration, the foam is extruded or deposited and then cut, if necessary.

Next, the marshmallows are dried in one or more drying steps to a moisture level that provides a water activity (a_{w}) ranging from 0.1-0.4, preferably 0.15-0.25, throughout the entirety of each resulting marbit (i.e., in the center of each marbit). Products dried to such water activity values are particularly suitable for addition to dry shelf-stable ready-to-eat products, such as RTE cereals, hot chocolate (added either to dry cocoa powders or directly to hot chocolate drink), oatmeal (including instant oatmeal) or other dried products for hot cereals (e.g., hot farina), cereal bar products, granola and health bars, dried fruit bars, candy bars, dry mixes for baked goods and a variety of other snack products. By virtue of their low water activity, the dried marshmallows are also useful as confections per se.

This drying process is distinct from the subsequent heating or “toasting” process. Specifically, during a standard drying process, the marshmallows are not heated to a degree sufficient to cause caramelization of the saccharide component. To cause caramelization, the marshmallows themselves need to reach a certain temperature, with this temperature being dependent on the ingredients selected, particularly the saccharide component. In other words, a high air temperature alone will not cause caramelization if the marshmallows are not heated for a duration sufficient to raise their temperature to the caramelization temperature. In one exemplary drying process, the marshmallows are dried at temperatures in the range of 70-80° C., and the marshmallows reach temperatures in the range of 55-65° C. Thereafter, the marbits are heated in order to toast at least one outer surface portion of each marbit. In accordance with the invention, “toasting” results in a discernible outer surface color change (browning), while a center of the marbit remains unchanged, and establishes a flavor change, coming mainly from effects on the sugar and protein. Preferably, during the subsequent toasting process prior to which the marbits already exhibit a water activity ranging from 0.1-0.4 as discussed above, the marbits are heated, and the outer surfaces of the marbits reach temperatures in the range of 120-260° C., preferably 193-233° C. This heating can be accomplished using any of a wide variety of suitable methods. For example, the marbits can be heated by transporting the marbits through an oven using a conveyor belt, with this oven including one or more gas burners or infrared heating elements. Such processes cause one or more outer surface portions of a given marbit to brown, such as by caramelization in this area. Overall, the heating process proceeds through evaporative cooling, then heating of the surface(s), then toasting. Depending on the process employed, the entire outside of the marbit may or may not be uniformly browned. To provide for a more uniform appearance, coloring can be added during initial preparation of the marshmallows (i.e., with the saccharide, foaming and structuring components).

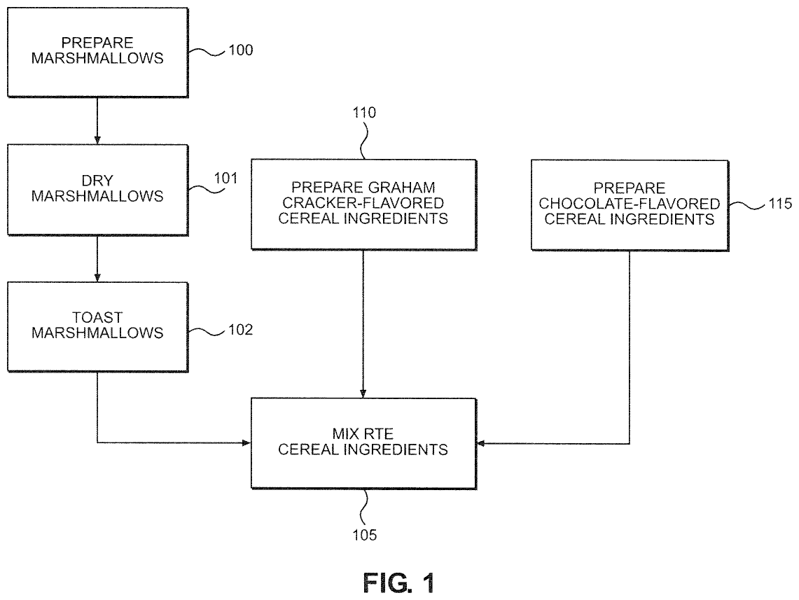

After heating, the toasted marbits are allowed to cool. At this point, the marbits can be packaged or incorporated into a desired food product. As noted above, RTE cereals and cereal bars represent exemplary preferred uses for the caramelized marbits of the present invention. One example is illustrated in FIG. 1. In steps 100-102, marshmallows are prepared, dried and toasted, as described above. Preferably, the resulting marbits are sized to have a piece count of 3-6 per gram. After cooling, the toasted marbits are mixed with other RTE cereal ingredients in step 105 to provide an RTE cereal. In the present example, these other RTE cereal ingredients include a graham-cracker flavored cereal ingredient and a chocolate-flavored cereal ingredient, which are prepared in steps 110 and 115, respectively. Preparation of these ingredients can, but need not, occur simultaneously. In one embodiment, Golden Grahams® brand RTE cereal is used as the graham cracker-flavored cereal ingredient, and Cocoa Puffs® brand RTE cereal is used as the chocolate-flavored cereal ingredient. Preferably, the RTE cereal ingredients are mixed in the following ratio to provide a s'mores flavored RTE cereal: 50% graham cracker-flavored cereal ingredient, 25% chocolate-flavored cereal ingredient and 25% toasted marbits. Of course, it should be recognized that other ratios can be used. Also, cereal bars can be prepared using these same ingredients (along with additional ingredients, as necessary).

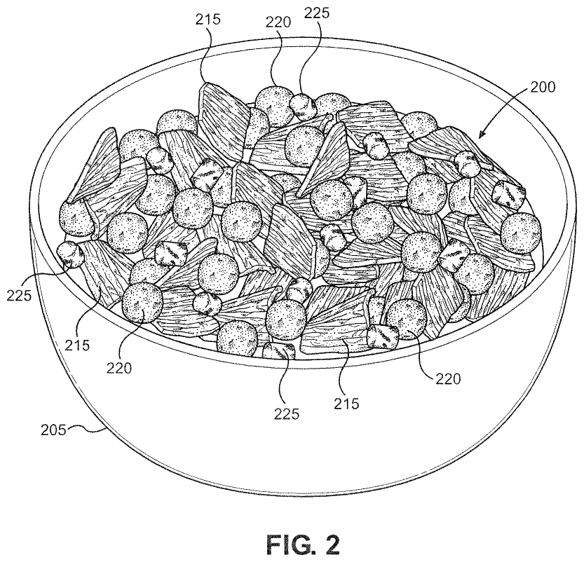

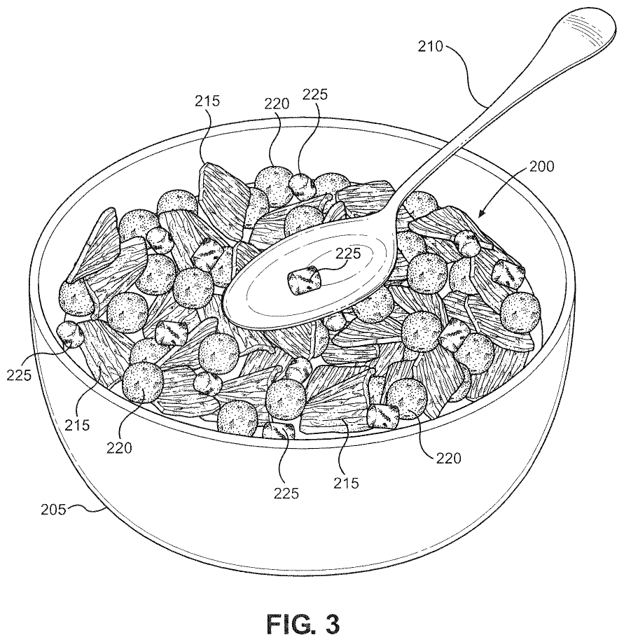

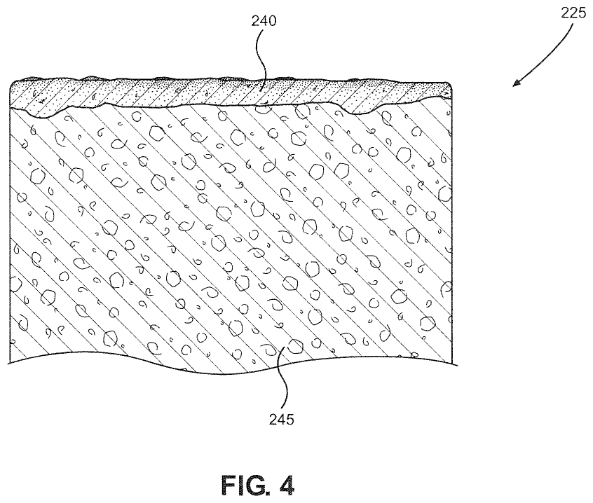

FIGS. 2 and 3 show an RTE cereal 200 prepared in accordance with the present invention. Specifically, RTE cereal 200 is a s'mores-flavored RTE cereal, which was prepared as described in connection with FIG. 1. For illustration purposes, RTE cereal 200 is shown in a bowl 205, with some of RTE cereal 200 supported on a spoon 210 in FIG. 3. RTE cereal 200 includes a graham-cracker flavored cereal ingredient 215, a chocolate-flavored cereal ingredient 220 and a plurality of toasted marbits 225. FIG. 4 shows a cross-section of a toasted marbit 225 illustrating that at least one outer surface portion 240 is toasted while a center portion 245 remains unaffected by the toasting process. Therefore, the outer surface portion 240 represents a depth of caramelization with a change from a crystalline structure toward a glassy structure. Here, outer surface portion has a thickness or depth of approximately 0.25 mm, such as 0.25 mm±0.05, while the largest dimension of marbit 225 is about 10 mm. Although only at least one outer surface portion of marbit 225 needs to be toasted, preferably marbit 225 is toasted on all, or at least multiple, sides, wherein the sides are non-uniformly toasted.

For purposes of the present invention, drying marshmallows does not encompass letting marshmallows go stale. Instead, the drying referred to involves an active step and occurs prior to packaging, distribution and sale. Again, this drying results in marbits having a water activity in the range of 0.1-0.4. The present invention is not intended to cover the roasting of stale marshmallows by a consumer, for example. In fact, it was found that non-dried (i.e., soft) marshmallows blister and deform during the toasting step of the present invention. Accordingly, non-dried marshmallows are not suitable for use in the present invention.

Based on the above, it should be readily apparent that the present invention provides dried marshmallow products having a novel flavor as well as a method of producing such products. While certain preferred embodiments of the present invention have been set forth, it should be understood that various changes or modifications could be made without departing from the spirit of the present invention. In general, the invention is only intended to be limited by the scope of the following claims.

1. A method of preparing a food product, the method comprising:
drying a marshmallow to establish a marbit; and
heating the marbit to a degree sufficient to toast at least one outer surface portion of the marbit in providing a toasted marbit.

2. The method of claim 1, wherein drying the marshmallow includes providing the marbit with a water activity in the range of 0.1-0.4.

3. The method of claim 2, wherein drying the marshmallow includes drying the marshmallow such that the water activity is in the range of 0.15-0.25 in the center of the marbit.

4. The method of claim 1, wherein heating the marbit includes heating the marbit such that the outer surface portion of the marbit reaches a temperature in the range of 193-233° C.

5. The method of claim 1, further comprising: mixing the toasted marbit with a plurality of food pieces, with the toasted marbit being mixed with the plurality of food pieces.

6. The method of claim 5, wherein mixing the toasted marbit with a plurality of food pieces includes combining the toasted marbit with a graham cracker-flavored cereal ingredient and a chocolate-flavored cereal ingredient to form a ready-to-eat cereal.

7. The method of claim 1, further comprising providing the toasted marbit in at least one of: an RTE cereal, hot chocolate, oatmeal, a hot cereal, a cereal bar product, a granola bar, a health bar, a dried fruit bar, a candy bar, and a dry mix for a baked good.

8. A marbit, wherein at least one side of the marbit is toasted.

9. The marbit of claim 8, wherein having a water activity in the range of 0.1-0.4.

10. The marbit of claim 9, wherein the water activity is in the range of 0.15-0.25 in a center of the marbit.

11. The marbit of claim 8, wherein the marbit includes multiple sides which are toasted.

12. The marbit of claim 11, wherein the multiple sides are non-uniformly toasted.

13. The marbit of claim 12, wherein all outer side portions of the marbit are toasted.

14. A food snack comprising:
a plurality of marbits each having at least one outer surface portion which is toasted; and
at least one additional food piece provided with the plurality of marbits.

15. The food snack of claim 14, wherein each toasted marbit having a water activity in the range of 0.1-0.4.

16. The food snack of claim 14, wherein each marbit includes multiple sides which are non-uniformly toasted.

17. The food snack of claim 14, wherein the at least one additional food piece includes a plurality of food pieces, with the toasted marbits being mixed with the plurality of food pieces.

18. The food snack of claim 17, wherein the plurality of food pieces are cereal pieces.

19. The food snack of claim 18, wherein the cereal pieces include a plurality of graham cracker-flavored cereal pieces and a plurality of chocolate-flavored cereal pieces.

20. The food snack of claim 14, wherein the toasted marbits are provided in at least one of: RTE cereals, hot chocolate, oatmeal, hot cereals, cereal bar products, granola and health bars, dried fruit bars, candy bars, and dry mixes for baked goods.
